(19) United States
(12) Patent Application Publication
(10) Pub. No.: US 2005/0118092 A1
(43) Pub. Date: Jun. 2, 2005

(54) Apparatus and method for inducing electrical property changes in carbon nanotubes

(76) Inventors: David Allara, State College, PA (US); Min Chen, Arlington, MA (US); Don Henley, Denton, TX (US); Timothy James Imholt, Carrollton, TX (US); James Andrew Roberts, Krum, TX (US)

Correspondence Address: Michael G. Cameron;Jackson Walker LLP, Suite 600, 2435 North Central Expressway, Richardson, TX, 75080, US

(21) Appl. No.: 10/936,007

(22) Filed: Sep. 7, 2004

Related U.S. Application Data
(60) Provisional application No. 60/506,858, filed on Sep. 29, 2003.

(51) Int. Cl. D01F 9/12; D01C 5/00; C09C 1/56; B05D 3/00

(52) U.S. Cl. 423/447.1; 423/447.2; 423/447.3; 427/553; 427/294

(57) ABSTRACT

An apparatus and process for fabricating carbon nanotubes (“CNTs”) with specific diameters and morphologies, comprising a vacuum system, CNT holder and microwave source adapted for directing a microwave field onto the CNTs. The morphology selection can yield samples of pre-selected diameter configurations making it possible to take a sample of SWNTs produced by any synthesis technique and induce a morphology change that causes the sample to be either all conductive, all narrow band gap semi-conductive or wide band gap semi-conductive, within a given nanotube rope.

### CROSS REFERENCE TO RELATED APPLICATION

This application is related to U.S. Provisional Patent Application No. 60/506,858, filed on Sep. 29, 2003, entitled “Induced Electrical Property Changes in Single Walled Carbon Nanotubes by Electromagnetic Radiation”, the entire contents of which are incorporated herein by this reference. The Applicants hereby claim the benefits of this earlier pending provisional application under 35 U.S.C. Section 119(e).

### BACKGROUND OF THE INVENTION

Carbon nanotubes (“CNTs”) were first observed in their multi-walled variety by Sumio Iijima at the NEC fundamental research laboratories. Multi-walled carbon nanotubes (“MWNTs”) can be thought of as a series of pipes within one another with anywhere from two to hundreds of layers. One of the many unique things about these carbon pipes is that their physical size is on the order of tens to hundreds of nanometers. MWNTs can be synthesized in a variety of methods such as arc discharge and laser ablation. Research on the properties of MWNTs and their synthesis eventually led to the observation of single-walled carbon nanotubes (“SWNTs”). SWNTs are pipes made of carbon on the scale of 0.7 nanometers to 5 nanometers. There are a number of different synthesis techniques to obtain SWNTs but the products of these processes and their properties remain very similar. While the structure of MWNTs are unique and interesting, SWNTs have received the majority of attention from researchers due to additional unique properties as compared to MWNTs.

The first observation of the SWNT was also recorded and published by Sumio Iijima and his coworkers at the NEC fundamental research laboratory. The discovery of SWNTs was made contemporaneously and independently in the United States. A SWNT essentially comprises a rolled up sheet of graphite which forms a very small, thin cylinder with no seam, and which is typically, although not always, closed at both ends. The lengths and diameters of SWNTs depend on a variety of conditions during the synthesis processes. The lengths of SWNTs are typically on the order of micrometers with diameters greater than 10 nanometers. SWNTs are therefore a novel pseudo one-dimensional material having many unique properties. During synthesis, SWNTs do not form as individual nanotubes but as “ropes” of nanotubes. These ropes appear just as normal ropes do in the macroscopic world, except that the strands are comprised of SWNTs and the overall diameter of the rope is typically less than 100 nanometers. Further, by known synthesis methods the ropes can be synthesized to be as small as 20 nanometers. These ropes are held together by an intermolecular Van der Waals force. Inside the ropes there are a plurality of different chirality and diameters of SWNTs. These different characteristics will cause the SWNTs to have a variety of different electrical properties, such as semiconducting or conducting. A mixture of the two types within the rope will restrict the individual CNT from being used as a semiconductor. If a rope comprises just one type of CNT, such as semiconducting of uniform type or bandgap, then it could be used as a semiconductor in an electronic device. The semiconductive nanotubes inside the ropes have electrical properties which allow them to be used in place of the more traditional silicon semiconductors. However, the ropes are very difficult to separate into their individual nanotube components. Separated nanotubes have only recently become available, and they are only available in very small quantities. The scarcity and cost of the separated nanotubes has limited the ability of researchers to build nanotube components into electronics.

It is generally known to those skilled in the art that to determine the nature of a particular individual nanotube as a conductor or a semiconductor, and the diameter of the nanotube under consideration must be determined and then a comparison made with experimental results in known literature. It is also generally known that if a sample of CNTs are sufficiently heated, their diameters will increase due to the coalescence of neighboring nanotubes. Previously, only exact doubling and tripling of CNT diameters was seen and reported in the literature.

Coalescence of carbon nanotubes in general is not a new phenomena. This effect was observed prior to 1991. The prior work involved fullerene molecules, which are the building blocks of nanotubes, coalescing into larger molecules. This phenomena was later seen in carbon nanotubes. In 1997, a mechanism was offered for these previous observations. It was observed that if a nanotube sample is heated in a controlled environment to 1400° C. for several hours, a small portion of the sample will exactly double in diameter and an even smaller portion of the sample will triple in diameter. If the experiment is performed in a hydrogen environment, the yield of diameter doubled nanotubes can be increased, indicating that a type of free radical chemistry is the mechanism for the phenomena. Nonetheless, the effect of diameter doubling still takes several hours, regardless of whether the heating is performed in a vacuum or in a hydrogen environment.

The work performed in 1997 suggests two explanations for the susceptibility of narrow diameter nanotubes to undergo a diameter change. The first is that the reactivity of a curved grapheme sheet increases as the tube diameter becomes smaller. This is because the curvature introduces more of an s-orbital effect into the π orbitals of the carbon atoms. The second is the coalescence of smaller diameter nanotubes is an exothermic reaction due to a release of strain energy.

What is desired is an apparatus and process for fabricating or altering the structure of CNT ropes that contain only semiconductive nanotubes that can be used as semiconductor devices in a variety of electronic devices and systems. Semiconductive nanotubes would have several advantages in addition to their semiconductive electrical properties. Semiconductive nanotubes have a reduced physical size over silicon devices and semiconductive nanotubes can handle much higher temperatures before breaking down. This makes them ideal for use in high performance devices.

### BRIEF DESCRIPTION OF THE DRAWINGS

FIG. 1 is a schematic of a rope of SWNTs between two electrical leads in a device;

FIG. 2 is a schematic of the current apparatus of the present invention;

FIG. 3 is a plot of Raman Breathing Modes of SWNT before and after microwave irradiation using laser excitation at a wavelength of 514 nm and power of 2 mW;

FIG. 4 is a plot of a SWNT sample Raman Spectra that has not been exposed to microwave radiation of any form; and

FIG. 5 is a plot of a SWNT sample Raman Spectra that has been exposed to 6 seconds of microwave radiation at 2.45 GHz and 420 Watts of power.

### SUMMARY OF THE INVENTION

The present invention achieves technical advantages in its ability to change the diameter of CNTs, not only in doublings and triplings, but more selectively. The apparatus and process of the present invention allows the user to select specific CNT diameters or morphologies. The morphology selection can yield samples of pre-selected diameter configurations, making it possible to take a sample of SWNTs produced by any synthesis technique and induce a morphology change that causes the sample to be either all conductive, all narrow band gap semiconductive or wide band gap semiconductive, within a given nanotube rope.

### DETAILED DESCRIPTION OF THE INVENTION

The interest in the CNTs was originally sparked by their physical size. The dimension at which CNTs exist is essentially a crossover point between the scale typically seen in consumer electronic devices and the molecular and atomic world. The small size of CNTs has attracted a great deal of interest in their electronic properties. It has been shown that the various diameters of SWNTs behave as both conductors and semiconductors. This fact, coupled with the additional fact that their thermal conductivity is high as compared to many other materials, suggests that if CNT's are used in electronic devices the lifespan of the devices could be greatly increased. The semiconductive type of CNT has been shown in some cases to perform in a manner similar to a silicon semiconductor. Advantageously, the similarity and behavior of CNTs to semiconductor devices, coupled with their much smaller size, suggest an increase in overall processing speed of the associated electronics. This has been demonstrated with a single molecule sized transistor.

However, many difficulties have been encountered in connection with CNT device fabrication. One difficulty with CNT device construction is that a single nanotube must be disentangled from a rope of nanotubes. Further, the removed nanotube must be of the desired type of semiconductive nanotube. This semiconductive nanotube must then be placed in the correct location on the device to achieve the desired result. Because of the scale of these structures, these steps are time consuming and prone to error.

Significant research into the synthesis process of SWNTs has been undertaken with the objective of fabricating a nanotube of just one type, semiconducting or conducting. Even if such a synthesis process develops, it may not be commercially viable due to low production yields typical of these processes. However, it is possible to fabricate CNT ropes in patterns and in chosen locations on a substrate. Thus, what is desired is a process and apparatus to change the CNT ropes, once grown, to contain CNTs of only one type. In such case, a molecular device could be fabricated. The present invention comprises an apparatus and method for achieving this objective by causing the selective coalescence of CNTs.

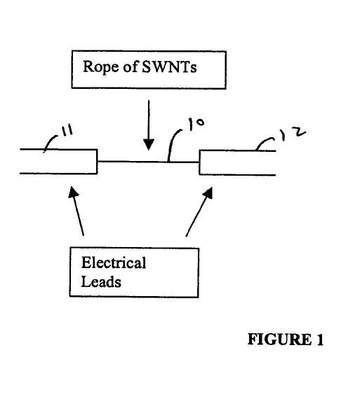

Referring to FIG. 1, using the present invention, a semiconductor device can be fabricated by growing a CNT rope 10 between two leads 11, 12 and then using the present invention to cause the CNTs 10 to have the desired characteristics.

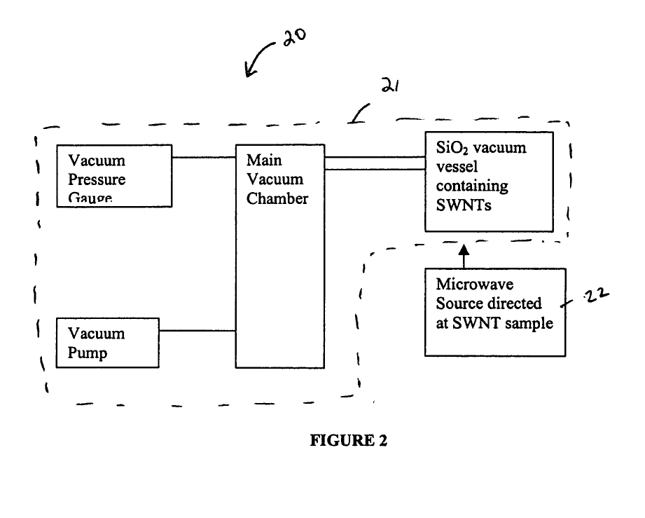

Referring to FIG. 2, the apparatus 20 of the present invention comprises a pre-defined area, such as vacuum system 21 capable of reaching between about 10⁻⁴ to 10⁻⁹ torr, preferably 10⁻⁵ torr or lower pressures, as the lower the pressure the more optimal the result as extensive oxidation of the sample is prevented, and a microwave source 22 capable of generating a frequency of between, 0.1 GHz and 100 GHz with a power output of between 0.001 Watt and 1,500 Watts, preferably about 2.45 GHz, at 400 Watts power, to achieve a microwave field of about 1.01×10⁻⁵ eV incident on a CNT, and a holder capable of holding a CNT in place in the pre-defined area. Another embodiment of the present invention can utilize an inert gas chamber for the pre-defined area. In this apparatus 20, the CNTs are exposed microwave radiation for the controlled amount of time, at the desired power and frequency, which causes a dramatic rise in temperature of the CNTs. Depending on the exposure time to this microwave radiation from the microwave source, the diameters of the CNTs will change to become larger than in the original sample. By adjusting the frequency, power level and exposure time, a sample of SWNTs can be shifted to having semiconductor properties or conductive properties. The apparatus of FIG. 2 provides but one embodiment of the apparatus employed to achieve the objectives of the present invention, however other embodiments can be used so long as they comprise, in general, a pre-defined area, such as a vacuum system or inert gas chamber, a microwave source, and a means of holding CNTs in place, as well as said apparatus in combination with CNTs. As seen in FIG. 2, the microwave source 22 is depicted external to the pre-defined area, here shown to be a vacuum system 21, however is not a requirement that the microwave source 22 be external to the pre-defined area. The microwave source, along with the SWNTs, may both be internal to the pre-defined area, such as a main vacuum chamber or inert gas chamber. Further, the CNT samples can also be placed in a microwave resonant cavity which is in communication with the microwave source so as to increase the efficiency of the process.

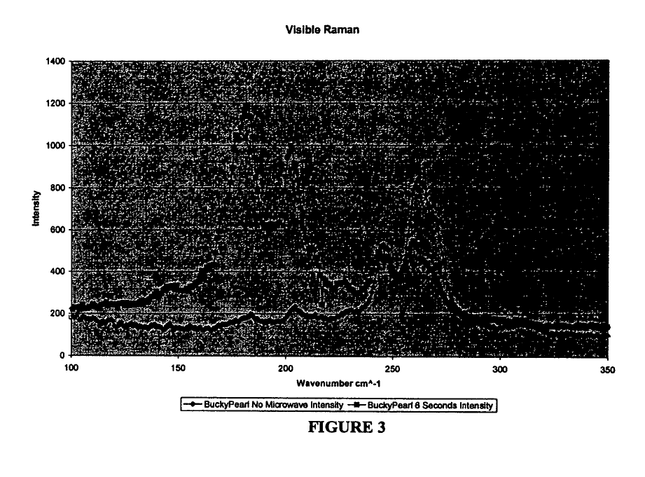

When a sample of carbon nanotubes is exposed to an appropriate frequency and power level of microwave radiation in the present invention, a diameter increase accompanied, although not as a diameter doubling, by a chirality shift is observed. FIG. 3 shows the Raman breathing modes of SWNT before and after microwave irradiation using laser excitation at a wavelength of 514 nanometers and a power of 2 milliwatts. In FIG. 3 the Raman spectra breathing modes can be seen for nanotubes not exposed to microwave irradiation 31 and Raman breathing modes for nanotubes that have been exposed to only 6 seconds of microwave irradiation 32. This exposure is much shorter than what was required previously. If these breathing modes are compared with the results of well known techniques, it can be seen that the diameter change is not a doubling effect but rather a diameter change from an average of 1.0 nanometer to 1.5 nanometers as seen in the present case, although this is not the only diameter and chirality shift observed. This diameter increase is associated with a chirality shift, causing the CNTs to consist of a much larger number of semiconducting nanotubes than existed prior to the exposure to the microwave field. This can be used to produce samples that are completely semiconductors or purely conductors.

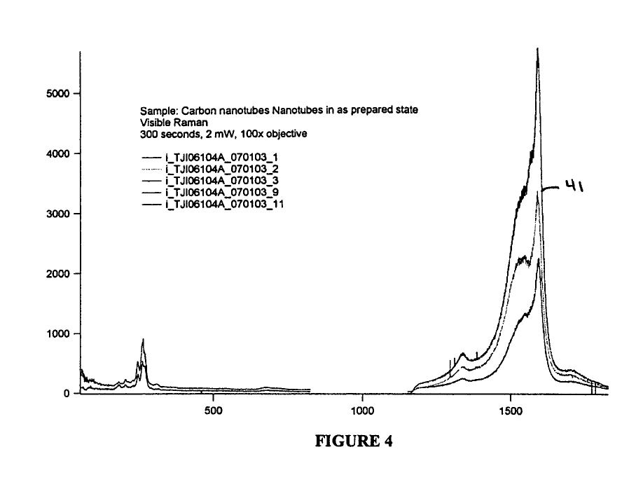

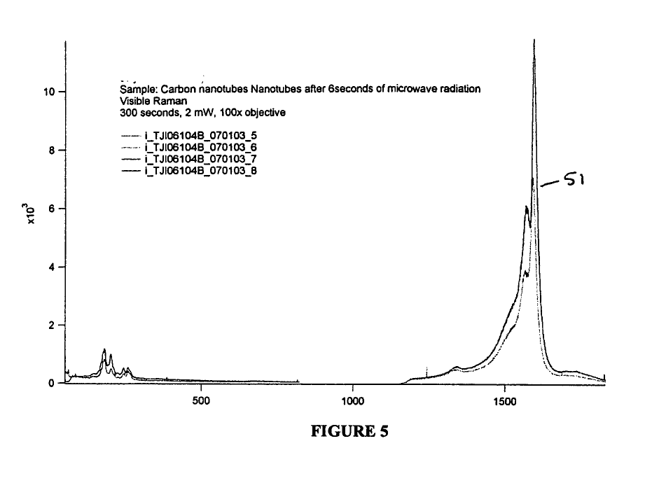

FIGS. 4 and 5 graphically illustrate further Raman evidence for this shift in morphology and electrical properties. In FIG. 4, a plot 41 of the Raman spectra of a SWNT sample produced by the HiPco process in a purified form, known as buckypearl, is shown. This sample has not been exposed to microwave radiation of any form. In FIG. 5, a plot 51 of a Raman spectra of a SWNT sample produced by the HiPco process in purified form, known as buckypearl, is also shown. Unlike the results of FIG. 4, the sample of FIG. 5 has been exposed to 6 seconds of microwave radiation at 2.45 GHz and 420 Watts of power, such that the field produced by this device is incident on the SWNTs. Frequencies from 2 GHz to 100 GHz can be used to produce this effect.

In addition to being able to convert the majority of, and in some cases, an entire sample of SWNTs into a semi-conducting state, a longer exposure has been shown to convert the entire sample back to a combination of conductors and semiconductors as the diameters continue to increase. It is hypothesized that the semi-conducting stage in the middle (from 4 to 7 seconds) is due to defects caused by a partially completed coalescence process. If the CNTs are exposed times to the microwave field for longer periods of time, the tube diameters will continue to increase until they are in a purely conducting state with little or no semi-conducting nanotubes remaining.

Conventional methods of growing individual ropes of CNTs in desired patterns or locations on a substrate are available. Once these ropes or groups of CNTs are in place, they can then be converted to having the desired characteristics by exposure to a microwave field using the present invention. Furthermore, it may be desired to change the characteristics of just one rope while leaving the one next to it on the circuit in a different form by selectively irradiating the rope to be converted. This can be achieved by exposing only the desired rope, for instance, by using STM tips which can be made to emit a microwave as well as image a structure. These tips can also be placed in a position on a sample with an accuracy in the angstrom range, thus allowing selective conversion of one part of a sample while the other samples on the substrate remain unaffected. This technique of small emitters with accurate placement can be used to construct a circuit from a single substance, e.g. SWNTs. The use of an STM is only one example of how the foregoing task could be performed.

The overall speed and efficiency of diameter changes can be greatly increased with the microwave process. Through selection of appropriate frequency and power levels of microwave radiation, in addition to environmental conditions, the resulting morphology of the CNT sample can be selected to whatever state is desired, e.g., narrow band gap semiconductor, wide band gap semiconductor or conductor. The present invention provides technical advantages in overall speed and selection capabilities over other types of CNT heating techniques. The present invention can also be used to cause mechanical motion of the CNTs being irradiated. This may be useful in the following applications: micrometers, nano-selfassembly, and nano-electronics actuators.

The innovative teachings of the present invention are described with particular reference to the apparatus and process used to selectively change the diameter and morphology of a CNT rope using specific microwave frequencies and power settings. It should be understood and appreciated by those skilled in the art that the use of the described embodiment to obtain the selective change in diameter and morphology of CNTs described herein provides only one example of the many advantageous uses and innovative teachings herein. Various alterations, modifications and substitutions can be made to the apparatus and method of the disclosed invention without departing in any way from the spirit and scope of the invention.

1. An apparatus for selectively changing the diameter and morphology of a carbon nanotube, comprising:
a pre-defined area;
a carbon nanotube holder located within the pre-defined area;
a microwave source; and
a guide for directing the microwave radiation from the microwave source toward a carbon nanotube located on the carbon nanotube holder located within the pre-defined area.

2. The apparatus of claim 1, in combination with a carbon nanotube.

3. The apparatus of claim 2, wherein the carbon nanotube is a single-walled nanotube (“SWNT”).

4. The apparatus of claim 1, wherein the pre-defined area is an inert gas chamber.

5. The apparatus of claim 1, wherein the pre-defined area is a vacuum chamber.

6. The apparatus of claim 5, wherein the vacuum chamber is adapted to create a vacuum pressure about the carbon nanotube of about 10⁻⁴ to 10⁻⁹ torr.

7. The apparatus of claim 6, wherein the vacuum chamber is adapted to create a vacuum pressure about the carbon nanotube of about 10⁻⁵ torr.

8. The apparatus of claim 1, wherein the microwave source and guide are capable of irradiating a carbon nanotube in a microwave field of about 1.01×10⁻⁵ eV.

9. The apparatus of claim 1 wherein the microwave source emits microwave radiation with a frequency of between 0.1 GHz and 100 GHz with a power output of between 0.001 Watt and 1,500 Watts and the carbon nanotube holder is about 5 millimeters to 0.1 meters from the microwave source.

10. The apparatus of claim 8, wherein the microwave source emits microwave radiation with a frequency of about 2.45 GHz at 400 Watts and the carbon nanotube holder is about 5 millimeters to 0.1 meters from the microwave source.

11. The apparatus of claim 1 further comprising a microwave resonant cavity adapted to increase the efficiency of the microwave source is coupled to the microwave source.

12. The apparatus of claim 1 further comprising being adapted for fabricating carbon nanotube semi-conducting devices.

13. An apparatus for selectively coalescing a carbon nanotube, comprising:
a pre-defined area;
a carbon nanotube holder located within the pre-defined area;
a microwave source; and
a guide for directing the microwave radiation from the microwave source toward a carbon nanotube located on the carbon nanotube holder located within the pre-defined area.

14. The apparatus of claim 13, wherein the pre-defined area is an inert gas chamber.

15. The apparatus of claim 13, wherein the pre-defined area is a vacuum chamber.

16. A process for selectively changing the diameter and morphology of a carbon nanotube, comprising:
placing a carbon nanotube in a vacuum area;
creating a vacuum in the vacuum area; and
exposing the carbon nanotubes to a microwave field of about 1.01×10⁻⁵ eV.

17. The process of claim 15 wherein the vacuum pressure is about 10⁻⁴ to 10⁻⁹ torr and the microwave incident on the carbon nanotube is about 1.01×10⁻⁵ eV.

18. The process of claim 16, further comprising being adapted for fabricating carbon nanotube semi-conducting devices.

19. A process for causing mechanical motion of carbon nanotubes comprising:
placing a carbon nanotube in a pre-defined area; and
exposing the carbon nanotubes to microwave irradiation.

20. The process of claim 19, further comprising creating a vacuum in the pre-defined area.

21. A process for fabricating semi-conducting devices comprising:
placing a carbon nanotube in a pre-defined area; and
directing microwaves at a selected frequency, power level and time duration at the carbon nanotube:
exposing the carbon nanotubes to said microwave irradiation.
achieving a partially completed, yet stable coalescence of the single-walled carbon nanotubes;
inducing the desired band gap for the desired semi-conducting devices or structures; and
subjecting the carbon nanotubes to an additional time duration sufficient to convert the coalesced single-walled carbon nanotubes into conductors, semi-conducting devices, or structures.
